(19) United States
(12) Patent Application Publication
(10) Pub. No.: US 2015/0058790 A1
(43) Pub. Date: Feb. 26, 2015

(54) ELECTRONIC DEVICE AND METHOD OF EXECUTING APPLICATION THEREOF

(71) Applicant: Samsung Electronics Co., Ltd., Suwon-si (KR)

(72) Inventors: Jongmin KIM, Busan (KR); Busic KOAG, Gumi-si (KR); Eunae JUNG, Gumi-si (KR); Jongwu BAEK, Gumi-si (KR); Jooyong KIM, Daegu (KR); Inhyung JUNG, Gumi-si (KR)

(21) Appl. No.: 14/462,855

(22) Filed: Aug. 19, 2014

(30) Foreign Application Priority Data
Aug. 23, 2013 (KR) 10-2013-0100293

(51) Int. Cl. G06F 3/0481; G06F 3/0488

(52) U.S. Cl. CPC G06F 3/0481; G06F 3/0488
USPC 715/781; 715/764

(57) ABSTRACT

A method of executing an application of an electronic device is provided. The method includes acquiring, by an electronic device, input data through a user interface unit, providing an application list through the user interface unit, selecting at least one application from the application list, determining a function to be performed through the at least one application based on the input data, and providing the function through the user interface unit.

### CROSS-REFERENCE TO RELATED APPLICATION(S)

This application claims the benefit under 35 U.S.C. §119(a) of a Korean patent application filed on Aug. 23, 2013, and assigned Serial number 10-2013-0100293, the entire disclosure of which is hereby incorporated by reference.

### TECHNICAL FIELD

The present disclosure relates to an electronic device including a user interface unit and a method of executing an application thereof

### BACKGROUND

Recently, the touchscreen market has been growing tremendously. Particularly, in terminal/notebook markets, touch panels have been gradually mounted, and as touchscreen panels have been generally used in most smartphones, the touchscreen market for portable devices has grown rapidly. In addition, touchscreen panels have been increasingly used in home appliances, and this field is expected to occupy a large part as a field in which a touchscreen panel is to be used.

A touchscreen has a structure in which a surface for detecting an input and a surface for displaying output overlap each other. A touchscreen-based electronic device can analyze and recognize a user's intention input based on a touch gesture, and output a result of the analysis and recognition. For example, a user can receive touch input on a touchscreen and transfer a control command to the device, and the device can analyze and recognize a user's intention through touch input sensing (e.g., touch input detecting), process an operation based on the analysis and recognition, and then output a processing result through the touchscreen.

As described above, the user interface of an electronic device has been gradually improved to use an intuitive and efficient method. For example, the functions of the electronic device are easily performed and the electronic device have been conveniently operated through button input, handwriting input using the hand or a simple tool, and various interfacing schemes.

A user can receive various desired functions through applications in an electronic device such as a terminal. In general, in order to receive a specific convenient function through a terminal, a user performs operations for activating a related application and performing a corresponding function of the activated application. As a touchscreen is introduced, a user can execute an application more intuitively and efficiently.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method capable of performing a function of an application more conveniently and efficiently.

In accordance with an aspect of the present disclosure, a method of executing an application of an electronic device is provided. The method includes acquiring, by an electronic device, input data through a user interface unit, providing an application list through the user interface unit, selecting at least one application from the application list, determining a function to be performed through the at least one application based on the input data, and providing the function through the user interface unit.

In accordance with another aspect of the present disclosure, an electronic portable device is provided. The electronic device includes a user interface unit, and a control unit configured to acquire input data through the user interface unit, to provide an application list through the user interface unit, to select at least one application from the application list, to determine a function to be performed through the at least one application based on the input data, and to provide the function through the user interface unit.

According to various embodiments of the present disclosure, a user can perform functions of applications by using an intuitive user interface in a more convenient manner. For example, when user input is input through the user interface unit and then an arbitrary application is selected, it is possible to automatically perform an arbitrary function of the application according to the selected application and the attribute of the input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a schematic configuration of an electronic device according to an embodiment of the present disclosure;

FIGS. 2 and 3 are flowcharts illustrating a method of executing an application of an electronic device according to an embodiment of the present disclosure;

FIG. 4 is a flowchart illustrating a method of executing a communication application of an electronic device according to various embodiments of the present disclosure;

FIGS. 5A, 5B, 5C, and 5D are exemplary diagrams of a screen for explaining a method of executing a communication application of an electronic device according to various embodiments of the present disclosure;

FIG. 6 is a flowchart illustrating a method of executing a schedule management application of an electronic device according to various embodiments of the present disclosure;

FIGS. 7A, 7B, 8A, 8B, and 8C are exemplary diagrams of a screen for explaining a function execution method of a schedule management application of an electronic device according to various embodiments of the present disclosure;

FIG. 9 is a flowchart illustrating a method of executing a map application of an electronic device according to various embodiments of the present disclosure; and

FIGS. 10A, 10B, 10C, 10D, 11A, 11B, and 11C are exemplary diagrams of a screen for explaining a method of executing a map application of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

Before detailed descriptions through embodiments, an electronic device including a user interface unit to be described in the present specification and drawings indicates a display device designed to analyze and recognize a contact part on the user interface unit when a user generates input on the user interface unit by using hand or a touch pen shaped like a ballpoint pen.

A user input section of the user interface unit according to an embodiment of the present disclosure may employ resistive type, capacitive type, electromagnetic induction type, pressure type, and other various types of touch detection technologies.

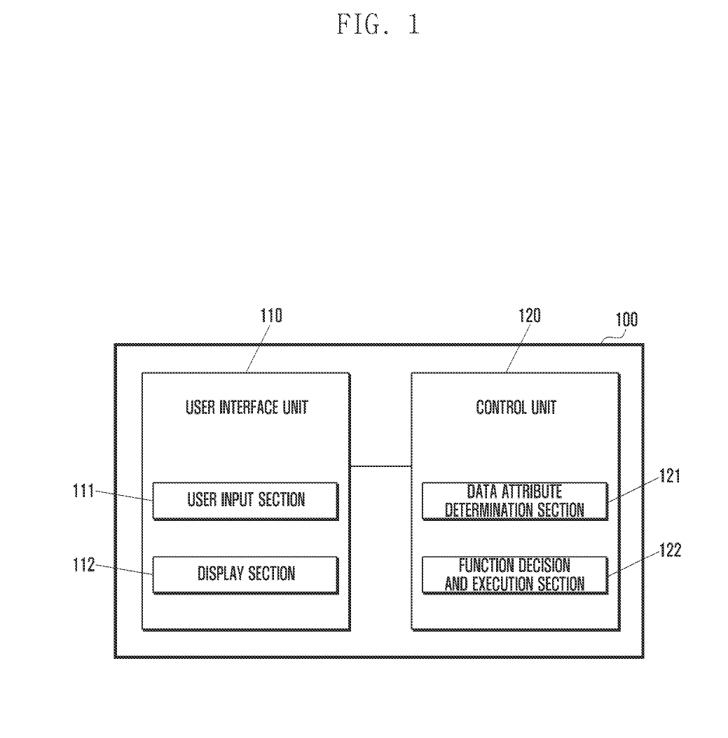

FIG. 1 is a diagram illustrating a schematic configuration of an electronic device according to an embodiment of the present disclosure.

Referring to FIG. 1, an electronic device 100 may include a user interface unit 110 and a control unit 120.

The user interface unit 110 may include a touchscreen that performs touch input reception and display operations. In detail, the user interface unit 110 may include a user input section 111 and a display section 112.

The user input section 111 may receive a user's touch input that is generated on the surface of the touchscreen. In detail, the user input section 111 may include a touch sensor that detects the user's touch input. The touch sensor may detect a proximity input in a predetermined distance (e.g., a point over input), as well as direct touch input according to an implementation scheme thereof. The user's touch input may include data input having specific information as well as arbitrary gesture input. According to various embodiments of the present disclosure, the data input having specific information is defined as input data. In addition, the user input section 111 may include a camera capable of selecting a function based on user eye tracking and an audio capable of receiving user voice input.

The display section 112 displays information that is processed in the electronic device 100. For example, the display section 112 may display an operation state of an application being executed.

The control unit 120 may control the general operation of the electronic device 100.

When user input is received through the user interface unit 110 and input data is confirmed from the user input, the control unit 120 controls an application menu to be displayed on the user interface unit 110. At this time, the input data may be received by handwriting through the touchscreen, or may be received by image or voice input through the camera or the audio. At this time, a partial area of the user input may be selected as the input data. In the case of using the touchscreen, the input data may be selected through a touch gesture such as a closed curve, and in the case of using the camera, the input data may be selected by tracking user eyes. In the case of using the audio, the input data may be selected through user voice input.

When the input data is confirmed, the control unit 120 may control the application menu including arbitrary applications to be displayed on the user interface unit 110.

In addition, the control unit 120 may divide and convert the input data into meaningful data available as input of an application, and the application menu including applications having association to be displayed on the user interface unit 110 according to a use pattern of the divided and converted input data.

When touch input for selecting an arbitrary application from the application menu is received, the control unit 120 may determine the attribute of the input data based on the selected application. Then, the control unit 120 may decide a function to be performed in the application according to the determined attribute of the input data. When the function to be performed in the application is decided, the control unit 120 may perform the function of the corresponding application by employing the input data as input, and display an execution operation through the user interface unit 110.

In detail, the control unit 120 may include a data attribute determination section 121 and a function decision and execution section 122.

The data attribute determination section 121 determines the attribute of input data received in the user interface unit 110 when an arbitrary application is selected from the application menu. The attribute of the input data may include the type of the input data, the number of data constituting the input data, order information of a plurality of data when the plurality of data constitutes the input data, and/or the like. The attribute of the input data may be decided on the consideration of a use pattern of the input data for the selected application.

In detail, the type of the input data may be decided (e.g., determined) according to items (e.g., characters, numerals, or signs) constituting the input data, and an arrangement type of the items based on the selected application. For example, in the case of a communication application, when input data including consecutive numerals is detected, the type of the input data may be determined as a phone number.

The number of data constituting the input data may be decided according to whether the input data includes data having data types different from each other. In addition, when the input data includes delimiters indicating word spacing, line breaking and the like, the number of data may be decided based on the delimiter.

The order information of the plurality of data in the input data, for example, may be decided according to the input directionality or input time of each data when the plurality of data is included in the input data.

The data attribute determination section 121 may derive a valid data type according to the selected application and determine whether the input data corresponds to the derived valid data type (e.g., the data attribute determination section 121 may perform validity examination for the input data). The valid data type indicates a data type available as input data for the selected application. For example, when a communication application is selected, a phone number including consecutive numerals or a contact name including a text may be derived as the valid data type. According to various embodiments of the present disclosure, in the validity examination for input data, when an unnecessary character is included in the valid data type, the data attribute determination section 121 may include a function of deleting the corresponding character. Furthermore, in the case in which the core character of the valid data type exists in the selected application, when a character similar to the core character exists in the input data, the data attribute determination section 121 may include a function of converting the similar character into the core character (e.g., in the case of an E-mail type, converting into @).

When data of the valid data type does not exist in the input data, the control unit 120 may block the execution of the selected application.

The function decision and execution section 122 decides a function to be performed in the selected application according to the determined attribute of the input data, and performs the corresponding function. For example, when a communication application is selected and the attribute of input data is determined as a phone number, the function decision and execution section 122 may decide that the communication application performs a communication function by using the phone number, and execute the communication application. When the number of the input data is determined to be plural, a corresponding application may perform a multifunction by employing each data as input. A detailed description thereof will be given below.

The application function execution content in the function decision and execution section 122 may be displayed through the user interface unit 110.

Because the detailed configuration of the control unit 120 as described above is an example for operation description, the present disclosure is not limited thereto, and those skilled in the art should sufficiently understand that the control unit 120 performs the general operations.

When point over input for an arbitrary application is received in the application menu displayed on the user interface unit 110, the control unit 120 may analyze input data based on the application selected by the point over input and control an analysis result to be displayed on a preview window. The analysis result may indicate data of the input data, which is determined as a valid data type based on the application, in other words, a result obtained by extracting valid data from the input data. For example, in the case of selecting a communication application, when there is data of the input data, which is determined as a phone number, the control unit 120 may extract the data as valid data and control the data to be displayed. According to various embodiments of the present disclosure, the analysis result may also indicate a result obtained by performing a function of an application determined according to the attribute of valid data of the input data.

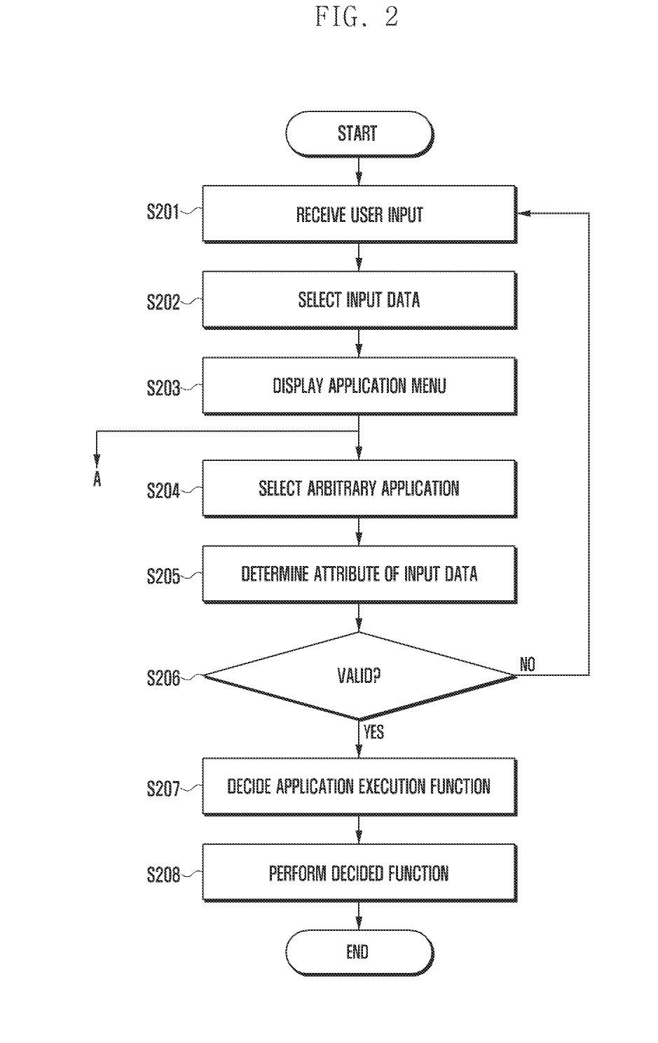

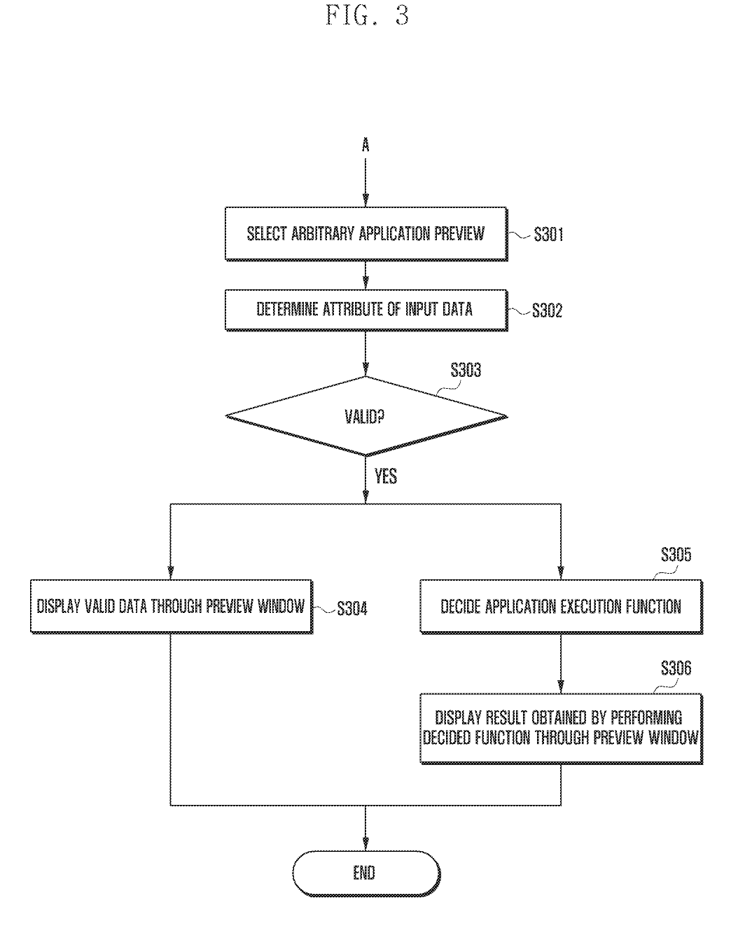

FIGS. 2 and 3 are flowcharts illustrating a method of executing an application of an electronic device according to the embodiment of the present disclosure.

Referring to FIG. 2, at operation S201, the electronic device may receive user input through the user interface unit.

Thereafter, at operation S202, the electronic device may receive input that selects desired data of the user input, which is displayed on the user interface unit, as input data. At this time, the input, which selects the input data, may be performed through various interfacing operations as well as various touch gestures for setting a range.

When the input data is selected (e.g., when the electronic device finally detects the input data), at operation S203, the electronic device displays the application menu on the user interface unit. For example in response to selection of the input data, the electronic device displays the application menu on the user interface unit.

At operation S204, a user may select an arbitrary application from the application menu displayed on the user interface unit, and the electronic device detects the application selection input.

When the application selection input is detected (e.g., in response to selection of the application), at operation S205, the electronic device may determine the attribute of the input data based on the selected application.

At this time, at operation S206, the electronic device may determine whether the input data is a valid data type of the selected application.

If the electronic device determines that the input data is the valid data type at operation S206, then the electronic device may proceed to operation S207 at which the electronic device may determine an application execution function according to the selected application and the data attribute of the input data.

In contrast, if the electronic device determines that the input data is not the valid data type at operation S206, then the electronic device may block the execution of the selected application and receive user input again.

When the application execution function is decided, at operation S208, the electronic device may perform the decided function by employing the input data as input in the corresponding application. For example, in response to the deciding of the application execution function, the electronic device may perform the decided function. The performed application function may be provided to a user through the user interface unit.

FIG. 3 illustrates an embodiment of the operation of the electronic device when preview request input, such as point over input, for an arbitrary application is received after the application menu is displayed on the user interface unit according to an embodiment of the present disclosure.

Referring to FIG. 3, at operation S301, when the point over input is received for the arbitrary application of the displayed application menu, the electronic device detects the point over input as preview selection input for the corresponding application.

Thereafter, at operation S302, the electronic device may determine the attribute of input data based on the corresponding application.

At operation S303, the electronic device may determine whether a valid data type is included in the input data in operation S303.

If the electronic device determines that the valid data type is included in the input data at operation S303, then the electronic device may proceed to operation S304 or S305 depending on the setting. At operation S303, the electronic device may display valid data of the input data on the user interface unit through a preview window. For example, the electronic device may provide a user with an opportunity capable of confirming data to be input to the application.

At operation S305, the electronic device may decide an application execution function according to the attribute of the valid data of the data input. Thereafter, at operation S306, the electronic device may display a result obtained by performing the decided function (e.g., a result obtained by performing the function by employing the valid data as input in the corresponding application), on the user interface unit through the preview window. In contrast, if the electronic device determines that the valid data type is not included in the input data at operation S303, then the electronic device may block the execution of operation S304 or S305 and receive user input again.

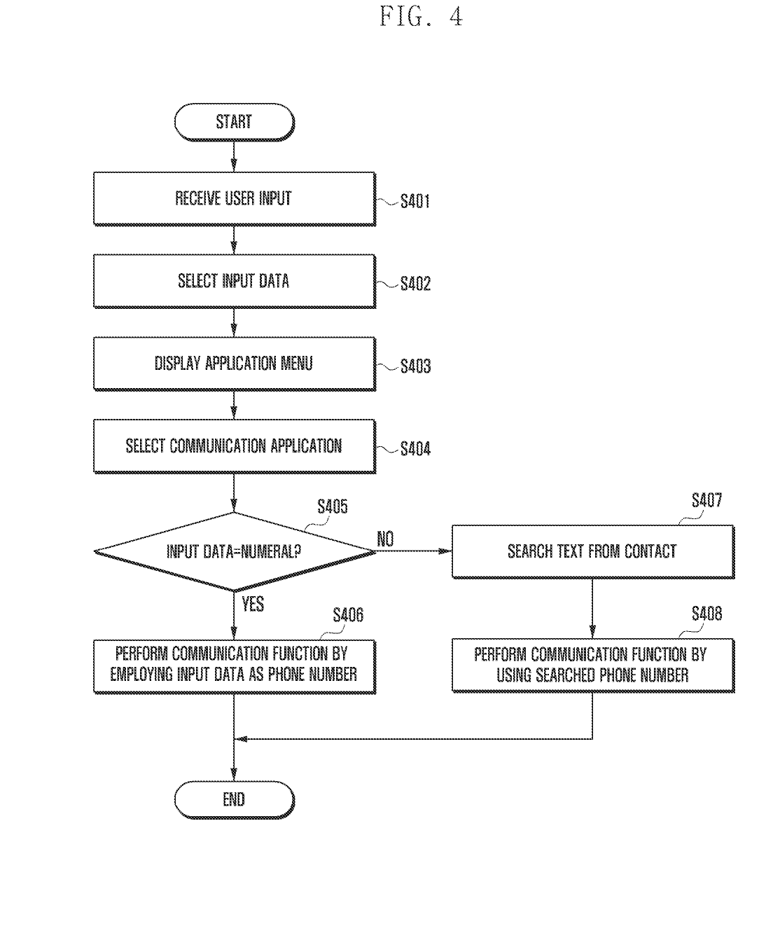

FIG. 4 is a flowchart illustrating a method of executing the communication application of an electronic device according to various embodiments of the present disclosure.

Referring to FIG. 4, at operation S401, an electronic device according to various embodiments of the present disclosure receives user input through the user interface unit.

At operation S402, the electronic device receives input for selecting input data of the user input.

At operation S403, the electronic device displays the application menu on the user interface unit.

At operation S404, a communication application function is selected. For example, the electronic device may receive an input for selection of the communication application.

In response to selection of the communication application at operation S404, the electronic device may proceed to operation S405 at which the electronic device may determine whether consecutive numerals are included in the input data in order to determine the attribute of the input data. For example, the electronic device may determine whether the input data corresponds to numerals.

If the electronic device determines that the consecutive numerals are included in the input data at operation S405, then the electronic device may proceed to operation S406 at which the electronic device may recognize the input data, in more detail, valid data of the input data, as a phone number, and perform a communication function. According to various embodiments of the present disclosure, even when a new line character, a delimiter and the like are included in the input data, the electronic device may remove the new line character or the delimiter through validity examination, recognize a phone number, and perform the communication function. In addition, even when a sign such as ‘-’ is included among the consecutive numerals of the input data, the input may be set to be recognized as a phone number.

If the electronic device determines that the consecutive numerals are not included in the input data at operation S405, then the electronic device may proceed to operation S407 at which the electronic device may employ a text of the input data as a contact name and search for the text from contacts. At operation S408, the electronic device may perform the communication function by using the searched contact.

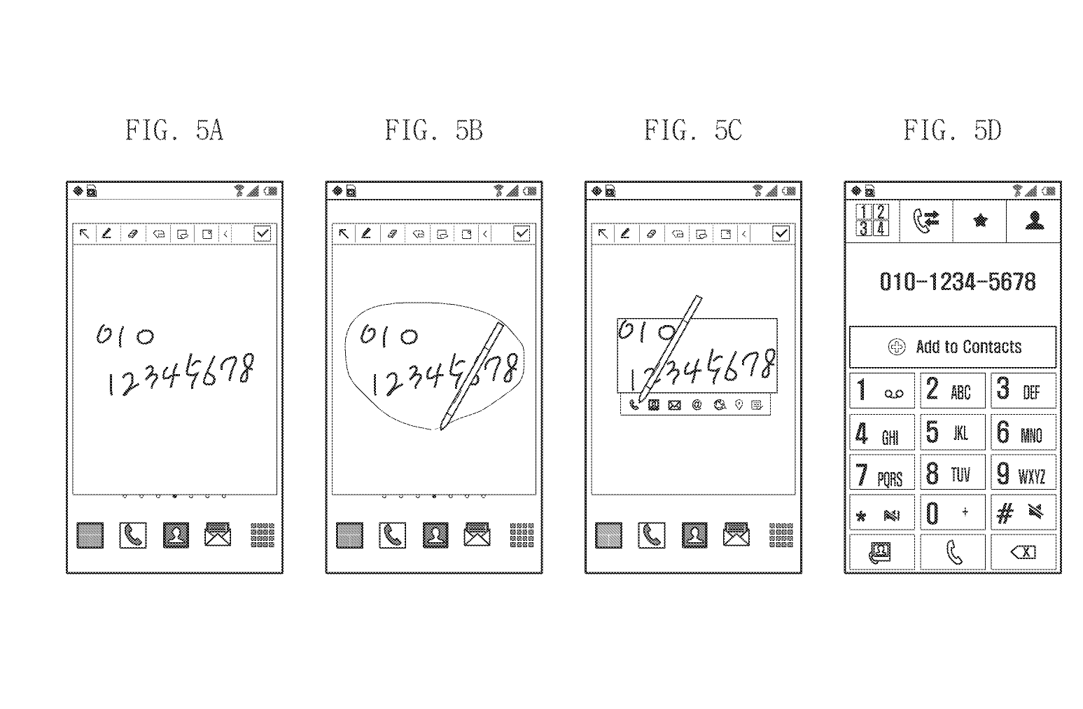

FIGS. 5A, 5B, 5C, and 5D are exemplary diagrams of a screen for explaining a method of executing the communication application of an electronic device according to various embodiments of the present disclosure.

Referring to FIG. 5A, user input received in the electronic device is illustrated. In order to receive the user input, the electronic device, for example, may execute an application for performing a memo function. Referring to FIG. 5B, selection of input data of the received user input is illustrated. Referring to FIG. 5C, display of the application menu and selection of the communication application from the application menu is illustrated. Referring to FIG. 5D, the electronic device determines the selected input data as a phone number according to the selection of the communication application, and performs a communication function by using the phone number.

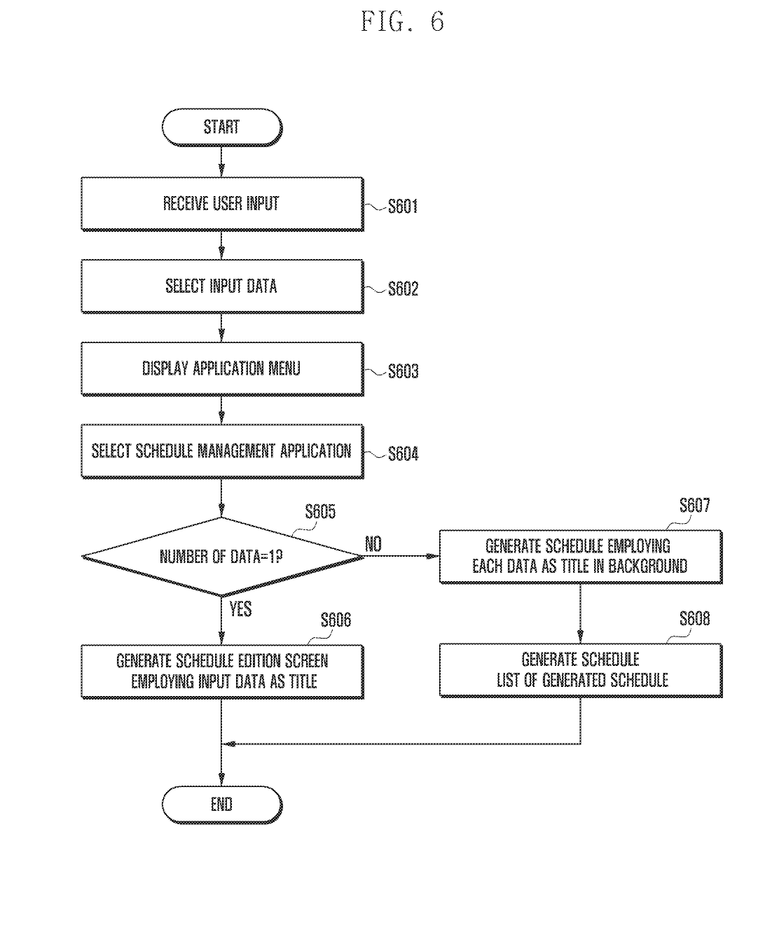

FIG. 6 is a flowchart illustrating a method of executing a schedule management application of the electronic device according to various embodiments of the present disclosure.

Referring to FIG. 6, at operation S601, the electronic device according to various embodiments of the present disclosure receives user input through the user interface unit.

At operation S602, the electronic device receives input for selecting input data of the user input.

At operation S603, the electronic device displays the application menu on the user interface unit.

At operation S604, a schedule management application function is selected. For example, the electronic device may receive an input for selection of the schedule management application.

In response to selection of the schedule management application at operation S604, the electronic device may proceed to operation S605 at which the electronic device may determine the number of data included in the input data in order to determine the attribute of the input data.

If the electronic device determines that the number of the data included in the input data is one at operation S605, then the electronic device may proceed to operation S606 at which the electronic device displays a schedule edition screen employing the input data, in more detail, valid data of the input data, as a title.

In contrast, if the electronic device determines that the number of the data included in the input data is plural (e.g., if the number of data included in the input data is greater than one) at operation S605, then the electronic device may proceed to operation S607 at which the electronic device generates a schedule employing each data as a title. Thereafter, at operation S608, the electronic device generates a schedule list of the generated schedule and displays the schedule list on the screen.

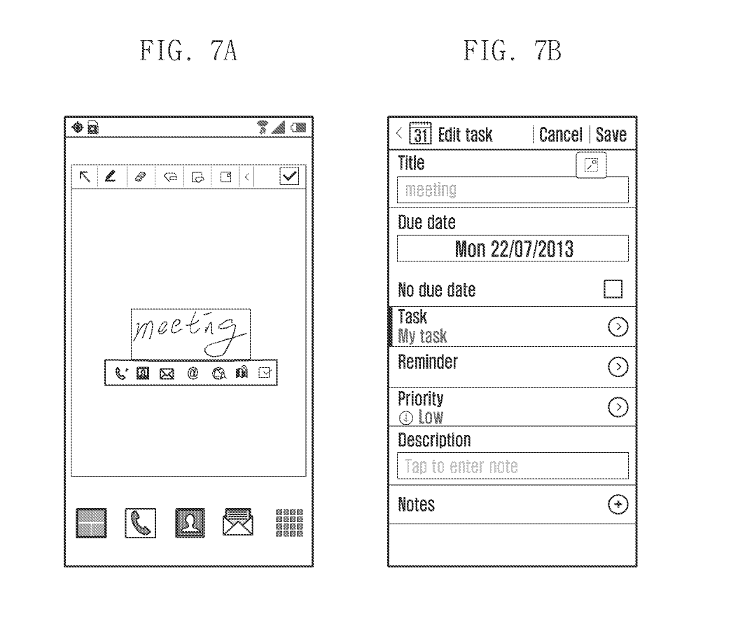

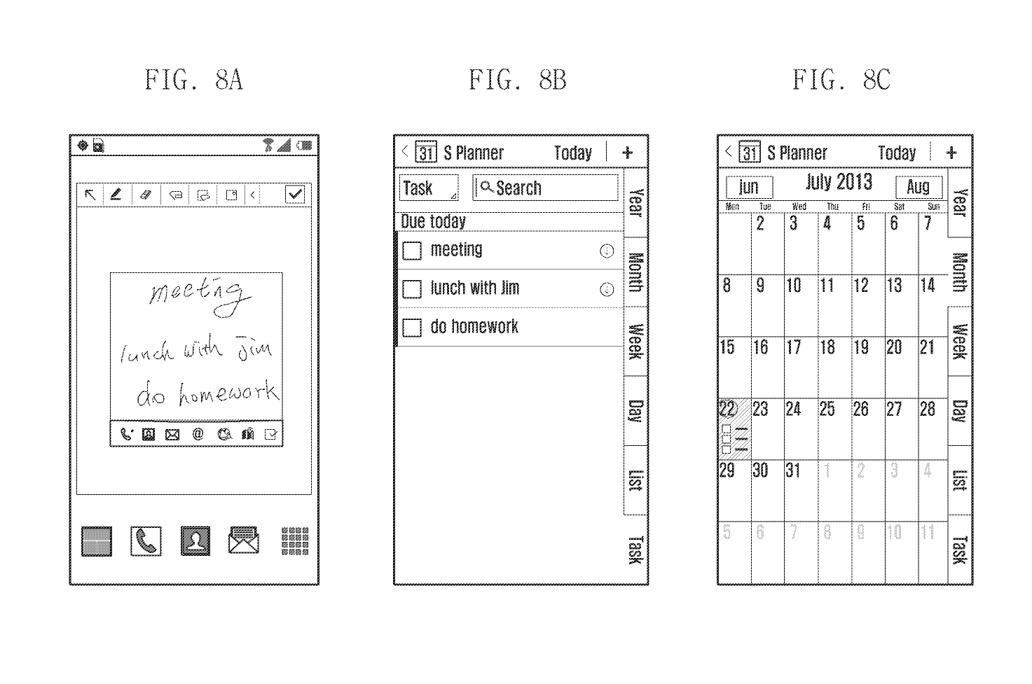

FIGS. 7A, 7B, 8A, 8B, and 8C are exemplary diagrams of a screen for explaining a function execution method of executing a schedule management application of an electronic device according to various embodiments of the present disclosure.

FIGS. 7A and 7B illustrate an embodiment of the present disclosure when the number of the data included in the input data is one. Referring to FIGS. 7A and 7B, in response input of single data and selection of the schedule management application, as illustrated in FIG. 7A, a schedule edition screen employing the data as a title is displayed, as illustrated in FIG. 7B.

FIGS. 8A, 8B, and 8C illustrate an embodiment when a plurality of data is included in the input data through line breaking for example. In response to input of a plurality of data and selection of the schedule management application, as illustrated in FIG. 8A, a schedule list screen, in which a schedule generated by employing each data as a title is displayed on one screen, is displayed as illustrated in FIGS. 8B and 8C. According to various embodiments of the present disclosure, FIG. 8B illustrates a screen for displaying a daily schedule list. According to various embodiments of the present disclosure, FIG. 8C illustrates a screen for displaying a monthly schedule list.

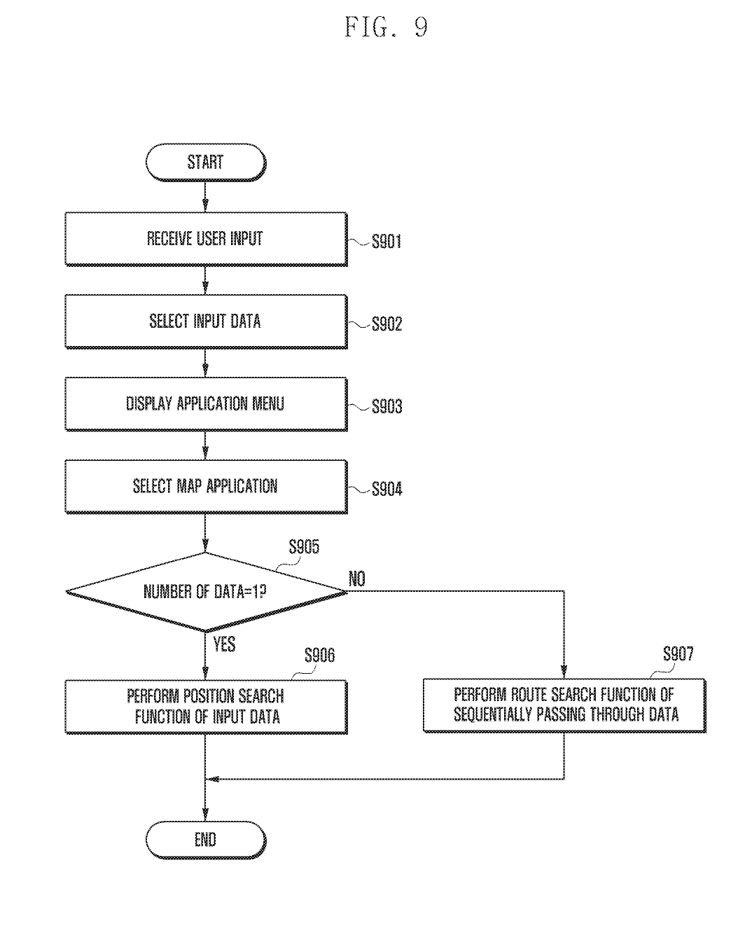

FIG. 9 is a flowchart illustrating a method of executing a map application of an electronic device according to various embodiments of the present disclosure.

Referring to FIG. 9, at operation S901, the electronic device according to various embodiments of the present disclosure receives user input through the user interface unit.

At operation S902, the electronic device receives input for selecting input data of the user input.

At operation S903, the electronic device displays the application menu on the user interface unit.

At operation S904, a map application function is selected. For example, the electronic device may receive an input for selection of the map application.

In response to selection of the map application at operation S904, the electronic device may proceed to operation S905 at which the electronic device may determine the number of data included in the input data in order to determine the attribute of the input data.

If the electronic device determines that the number of the data included in the input data is one at operation S905, then the electronic device may proceed to operation S906 at which the electronic device may perform a position search function for valid data of the input data.

In contrast, if the electronic device determines that the number of the data included in the input data is plural (e.g., if the number of data included in the input data is greater than one) at operation S905, then the electronic device may proceed to operation S907 at which the electronic device may determine time information attributes of each data and perform a route search function of sequentially passing through each data according to the time information attributes.

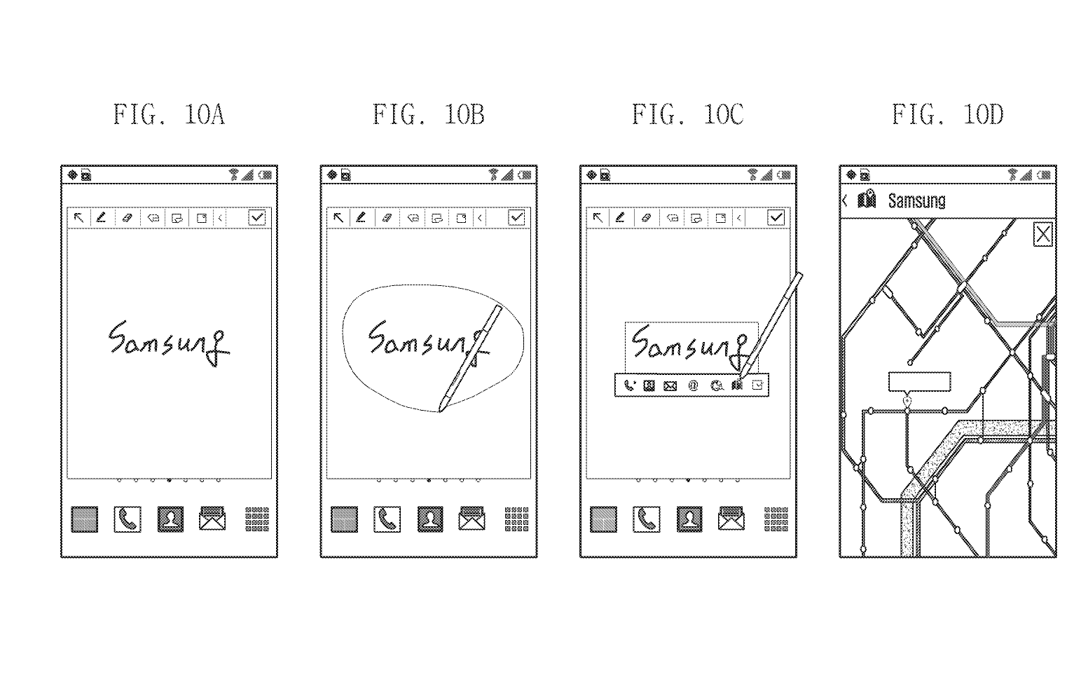

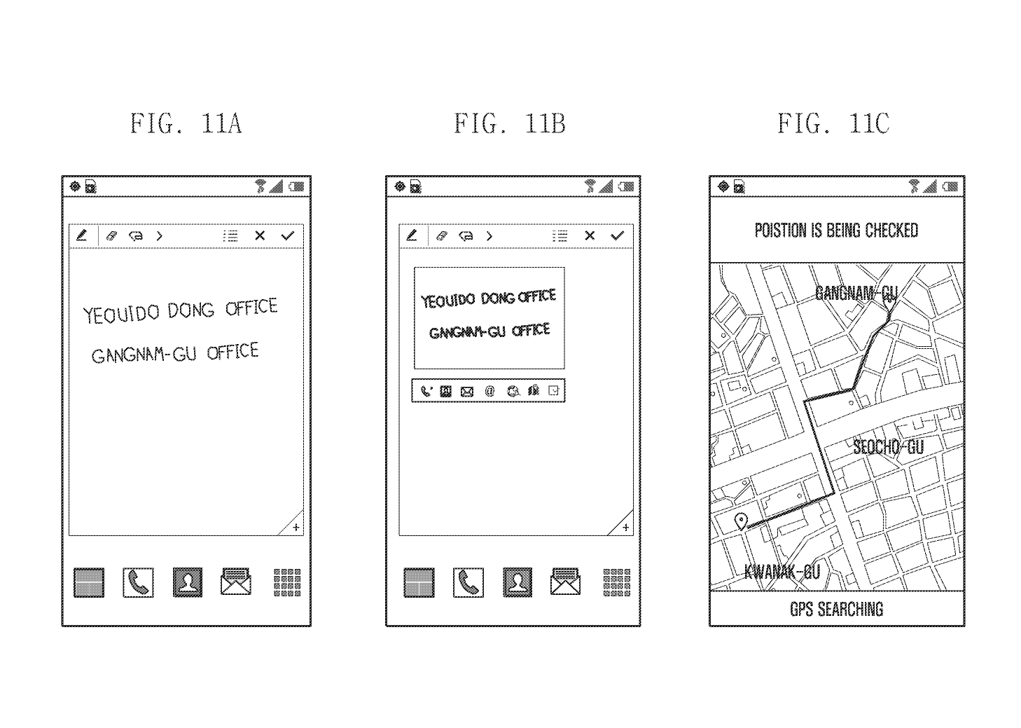

FIGS. 10A, 10B, 10C, 10D, and 11 are exemplary diagrams of a screen for explaining a method of executing a map application of an electronic device according to various embodiments of the present disclosure.

Referring to FIGS. 10A, 10B, 10C, and 10D, an embodiment of the present disclosure when the number of the data included in the input data is one is illustrated. When user input is received as illustrated in FIG. 10A, input data is selected as illustrated in FIG. 1 OB, and the map application is selected as illustrated in FIG. 10C, the electronic device may activate the position search function for the input data while executing the map application as illustrated in FIG. 10D.

Referring to FIGS. 11A, 11B, and 11C, an embodiment of the present disclosure when a plurality of data is included in the input data through line breaking for example. When a plurality of data is input as illustrated in FIG. 11A and the map application is selected from the application menu displayed on the user interface unit as illustrated in FIG. 11B, the electronic device may perform the route search function of sequentially passing through each data according to time information of each data, for example, an input order as illustrated in FIG. 11C.

According to various embodiments of the present disclosure, receiving input data and executing various applications is possible.

For example, in the case of executing a contact edition application, when input data is a text, employing the corresponding text as a contact name and displaying a contact edition screen is possible. When the input data includes text data and consecutive numeral data, employing the corresponding text data as a contact name, employing the consecutive numeral data as a phone number, and displaying a contact edition screen are possible. In addition, when the input data is recognized as URL, an E-mail address, a home address, and/or the like, editing information on each category in contacts is possible.

According to various embodiments of the present disclosure, in the case of executing an E-mail application, when input data is a text, employing the corresponding text as an E-mail title or body and performing an E-mail creation function are possible. According to various embodiments of the present disclosure, when the input data includes text data and E-mail data, employing the corresponding text data as an E-mail title or body, setting the E-mail data as a receiver, and performing the E-mail creation function are possible. According to various embodiments of the present disclosure, in order to improve a detection rate of the E-mail data, even when a new line character or a delimiter is included among the E-mail data, removing the new line character or the delimiter through validity examination, recognizing an E-mail, and performing a communication function are possible. For example, when a new line character exists prior to or next to a character ‘@’ that is a core character of an E-mail, removing the new line character and recognizing single E-mail data is possible. According to various embodiments of the present disclosure, in the case of a character ‘@’ that is difficult to be recognized due to the characteristics of handwriting, when a similar pattern (e.g., \textcircled{9} and the like) is input, searching for a unicode and forcibly converting the unicode into the character ‘@’ is possible.

According to various embodiments of the present disclosure, in the case of executing a message application, when input data is a text, employing the corresponding text as a body and performing a message creation function is possible. According to various embodiments of the present disclosure, when the input data includes text data and consecutive numeral data, employing the corresponding text data as a body, employing the consecutive numeral data as a phone number, and performing the message creation function are possible. According to various embodiments of the present disclosure, the input data includes E-mail data, searching for a phone number corresponding to the E-mail data from a contact list, employing a searched phone number as a receiver item, and performing the message creation function are possible.

According to various embodiments of the present disclosure, in the case of executing a conversation application capable of performing real-time chatting, when input data is recognized as a messenger ID or an E-mail ID, performing a function of requesting chatting with respect to the corresponding ID is possible. At this time, when the input data includes text data as well as ID, employing the text data as a body and performing a function of requesting chatting by using the corresponding ID are possible.

According to various embodiments of the present disclosure, in the case of executing a browser application, when input data is a text, employing the corresponding text as a search word and performing a search function are possible. When the input data includes URL information, moving a corresponding URL screen through a browser is possible.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method comprising:
acquiring, by an electronic device, input data through a user interface unit;
providing an application list through the user interface unit;
selecting at least one application from the application list;
determining a function to be performed through the at least one application based on the input data; and
providing the function through the user interface unit.

2. The method of claim 1, wherein the determining of the function to be performed comprises:
determining the function based on at least one of a type of the input data, a number of data, and order information of the data.

3. The method of claim 1, wherein the determining of the function to be performed comprises:
determining a plurality of functions based on each data when a number of the input data is plural.

4. The method of claim 1, wherein the determining of the function to be performed comprises:
determining validity of the input data based on the at least one application; and
determining the function when the input data is determined to be valid input data.

5. The method of claim 1, wherein the determining of the function to be performed comprises:
converting at least a part of the input data into designated data; and
determining the function based on the converted input data.

6. The method of claim 1, further comprising:
acquiring a point over input for at least one application of the list through the user interface unit; and
displaying information on a function, which is to be performed in the at least one application, through a preview window.

7. The method of claim 1, wherein the determining of the function to be performed comprises at least one of:
determining a communication-related function as the function based on the input data when the at least one application is a communication application; and
determining at least one of a new schedule generation function or a schedule search function as the function based on the input data when the at least one application is a schedule-related application.

8. The method of claim 1, wherein the determining of the function to be performed comprises:
determining at least one of a position search-related function and a road guidance-related function as the function based on the input data when the at least one application is a map-related application.

9. The method of claim 8, wherein the determining of the function to be performed comprises:
determining at least one of a search-related function for a plurality of positions and a road guidance-related function of passing through the plurality of positions as the function when a number of the input data is plural.

10. A non-transitory computer-readable storage medium storing instructions that, when executed, cause at least one processor to perform the method of claim 1.

11. The method of claim 1, wherein the providing of the function through the user interface unit comprises:
automatically inserting at least a portion of the input data into an applicable field for the provided function.

12. An electronic device comprising:
a user interface unit; and
a control unit configured to acquire input data through the user interface unit, to provide an application list through the user interface unit, to select at least one application from the application list, to determine a function to be performed through the at least one application based on the input data, and to provide the function through the user interface unit.

13. The electronic device of claim 12, wherein the control unit determines the function based on at least one of a type of the input data, a number of data, and order information of the data.

14. The electronic device of claim 12, wherein the control unit determines a plurality of functions based on each data when a number of the input data is plural.

15. The electronic device of claim 12, wherein the control unit determines validity of the input data based on the at least one application, and determines the function when the input data is determined to be valid input data.

16. The electronic device of claim 12, wherein the control unit converts at least a part of the input data into designated data, and determines the function based on the converted input data.

17. The electronic device of claim 12, wherein the control unit acquires a point over input for at least one application of the list through the user interface unit, and displays information on a function, which is to be performed in the at least one application, through a preview window.

18. The electronic device of claim 12, wherein the control unit determines a communication-related function as the function based on the input data when the at least one application is a communication application, and at least one of a new schedule generation function or a schedule search function as the function based on the input data when the at least one application is a schedule-related application.

19. The electronic device of claim 12, wherein the control unit determines at least one of a position search-related function and a road guidance-related function as the function based on the input data when the at least one application is a map-related application.

20. The electronic device of claim 19, wherein the control unit determines at least one of a search-related function for a plurality of positions and a road guidance-related function of passing through the plurality of positions as the function when a number of the input data is plural.
